(19) United States
(12) Patent Application Publication
(10) Pub. No.: US 2017/0046359 A1
(43) Pub. Date: Feb. 16, 2017

(54) HIGH RELIABILITY PARITY DECLUSTERING

(71) Applicant: SEAGATE TECHNOLOGY LLC, Cupertino, CA (US)

(72) Inventor: Nachiket Sahasrabudhe, Pune (IN)

(73) Assignee: SEAGATE TECHNOLOGY LLC, Cupertino, CA (US)

(21) Appl. No.: 14/825,965

(22) Filed: Aug. 13, 2015

(51) Int. Cl. G06F 17/30

(52) U.S. Cl. CPC G06F 17/30135; G06F 17/30082

(57) ABSTRACT

A method for high reliability parity declustering is described. In one embodiment, the method includes determining a number of available storage devices, dividing a file into a plurality of data units, assigning a number of the plurality of data units to a first parity group of one or more parity groups associated with the file, generating a number of parity units for the number of data units in the first parity group, generating a number of reserve units for the number of data units and the number of parity units in the first parity group, and sequentially allocating the number of data units, the number of parity units, and the number of reserve units of the first parity group across the number of available storage devices.

### SUMMARY

The disclosure herein includes methods and systems for high reliability parity declustering. In some embodiments, the present systems and methods may improve the reliability of a parity declustering storage system.

A method for high reliability parity declustering is described. In one embodiment, the method may include determining a number of available storage devices, dividing a file into a plurality of data units, assigning a number of the plurality of data units to a first parity group of one or more parity groups associated with the file, generating a number of parity units for the number of data units in the first parity group, generating a number of reserve units for the number of data units and the number of parity units in the first parity group, and allocating the number of data units, the number of parity units, and the number of reserve units of the first parity group across the number of available storage devices.

In some embodiments, the method may include determining a sequential order for the number of available storage devices from a first storage device to a last storage device and allocating the number of data units, number of parity units, and number of reserve units of the first parity group in the determined sequential order for the number of available storage devices. Upon reaching the last storage device while allocating data, parity, and reserve units from the one or more parity groups and determining one or more units remain unallocated, the method may include continuing to allocate the one or more remaining unallocated units in the determined sequential order starting over at the first storage device.

In some embodiments, the method may include allocating first the number of data units, then the number of parity units, and then the number of reserve units. In some cases, a single data unit, parity unit, or reserve unit is allocated per storage device. In some cases, the method may include calculating a unit sum. The unit sum may be based at least in part on a sum of the number of data units, the number of parity units, and the number of reserve units in the first parity group. Upon detecting a failure among at least one of the available storage devices, the method may include determining the file is recoverable if each of the one or more parity groups associated with the file has no more storage device failures than the number of parity units.

In some embodiments, a pattern of mapping between the one or more parity groups and the number of available storage devices is periodic based on a cycle value. The cycle value may be based at least in part on a least common multiple of the number of available storage devices and the unit sum. In one embodiment, the cycle value may be based at least in part on dividing the least common multiple of the number of available storage devices and the unit sum by the unit sum. Upon detecting a failure among at least one of the number of available storage devices, the method may include determining the file is recoverable if the number of recoverable parity groups is equal to or greater than the cycle value. Upon detecting a failure with at least one storage device associated with the first parity group, the method may include using a remainder of operating storage devices associated with the first parity group to recover data from the at least one storage device that failed. In some cases, the number of reserve units is equal to the number of parity units.

An apparatus for high reliability parity declustering is also described. In one embodiment, the apparatus may include a processor, memory in electronic communication with the processor, and instructions stored in the memory, the instructions being executable by the processor to perform the steps of determining a number of available storage devices, allocating a file into a plurality of data units, assigning a number of the plurality of data units to a first parity group of one or more parity groups associated with the file, generating a number of parity units for the number of data units in the first parity group, generating a number of reserve units for the number of data units and the number of parity units in the first parity group, and allocating the number of data units, the number of parity units, and the number of reserve units of the first parity group over the number of available storage devices.

A storage controller is also described. The storage controller may include a plurality of storage devices, a processor, and a network interface. The processor may determine a number of available storage devices among the plurality of storage devices. The network interface may receive a file. The processor may divide the file into a plurality of data units, assign a predetermined number of the plurality of data units to a first parity group of one or more parity groups associated with the file, generate a predetermined number of parity units for the predetermined number of data units in the first parity group, and generate a predetermined number of reserve units for the predetermined number of data units and the predetermined number of parity units in the first parity group. In some cases, the processor may sequentially allocate the predetermined number of data units, the predetermined number of parity units, and the predetermined number of reserve units of the first parity group over the number of available storage devices.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein—including their organization and method of operation—together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components—including those having a dash and a second reference label—apply to other similar components. If only the first reference label is used in the specification, the description is applicable to any one of the similar components having the same first reference label irrespective of the second reference label.

FIG. 1 is a block diagram of an example of a system in accordance with various embodiments;

FIG. 2 shows a block diagram of a device in accordance with various aspects of this disclosure;

FIG. 3 shows a diagram of an apparatus in accordance with various aspects of this disclosure;

FIG. 4 shows a diagram of an example parity declustering layout in accordance with various aspects of this disclosure;

FIG. 5 shows a diagram of another example parity declustering layout in accordance with various aspects of this disclosure;

FIG. 6 is a flow chart illustrating an example of a method in accordance with various aspects of this disclosure; and

FIG. 7 is a flow chart illustrating an example of a method in accordance with various aspects of this disclosure.

### DETAILED DESCRIPTION

The following relates generally to high reliability parity declustering. A parity declustered layout may divide a file into chunks. Each chunk of the file may be self-sufficient for its error correction. For example, each chunk may include one or more parity bits and/or parity bytes. In some cases, the chunk may be referred to as a parity group. Each parity group may be further divided into data, parity and spare blocks. If a parity group has N data blocks (blocks of file data), then K parities may be calculated over these N blocks and stored as parity blocks. Also, R reserve blocks may be included in each parity group. This configuration may ensure the reliability of any K out of N+K data and parity blocks. Blocks of parity group may be striped over disks such that each disk contains a maximum of a single block from any one parity group. This ensures that failure of any K disks leads to no more than K failures per parity group. Blocks of parity groups may be permuted over disks in such a way that in case of a disk recovery, load over each still-operating disk associated with an affected parity group is uniformly distributed. Thus, when a disk fails, lost data may be rebuilt using the remaining operational disks in the declustered array.

In one embodiment, the systems and methods described herein may include a parity declustered layout in which all parity groups from a particular file follow the same permutation to improve the probability of recovering more than K disk failures. For given values of N, K, R, and the number of total available storage devices P (i.e., the pool width), the probability of recovering from more than K failures may be more than about 90% under the file layout described herein. For example, with N=6, K=2, R=2, and P=80, the probability of a full recovery after 3 (K+1) storage device failures may be as high as 93%; the probability of a full recovery after 4 (K+2) failures may be as high as 81%; the probability of a full recovery after 5 (K+3) failures may be as high as 64%; the probability of a full recovery after 6 (K+4) failures may be as high as 46%. Similar observations may be achieved for different parameters. It is further noted, if the pool width P is divisible by (N+K+R), then increasing P by keeping N, K, and R constant may improve the probability of recovering more than K failures. As one example, if N=8 and K=2, and R=2, then the probability of recovering from K +1 (3 failures) goes as high as 99% when P goes to 360. In the case where (N+K+R) divides evenly into P, and we denote this division by Q (i.e., Q=[P/[N+K+R]]), then as Q grows, the probability of recovering more than K devices increases. Letting G=(N+K+R), then Q=P/G, and P=Q*G. In one embodiment, keeping N, K, and R constant and increasing P increases the probability of recovery in the iterations of G, i.e., P=Q*G, P=(Q+1)*G, P=(Q +2)*G, . . . and so on. On the other hand if we increase P without taking into account even divisibility by G, in some cases the probability may not improve. In some embodiments, different permutations may be used for each file. In some cases, using different permutations for each file may improve the recovery performance across different files. For example, a first file may be divided into chunks having a block size B1 and permuted based on values for N1, K1, and R1. Thus, the file may be permuted based on the block size, B1, and the values of N1, K1, and R1. P, the number of available storage devices, may be constant for each file. A second file may be divided into chunks with a block size B2 and permuted based on values N2, K2, and R2. One or more of the values B2, N2, K2, and R2 may be the same or different than the values B1, N1, K1, and R1, respectively. As one example, B1 and B2 may both be set to 128 kilobytes, whereas the N, data blocks, K parity blocks, and R reserve blocks for the respective files may be set to N1=6, K1=2, R1=2, and N2=8, K2=4, and R2=4. In some cases, B1 may be different than B2. In some cases, the number of data blocks, N, of one file may equal the number of data blocks of another file. Additionally, or alternatively, the number of parity blocks, K, and/or reserve blocks, R, of one file may equal the number of parity and/or reserve blocks of another file. In some cases, the number of data blocks, N, and parity blocks, K, for a given chunk of a file may be based on the number of available storage devices, P. For example, in one embodiment, N and K may be any whole number such that P is greater than or equal to the sum of N, K, and R (e.g., N+K+R).

Accordingly, a file may be associated with multiple parity groups. In one embodiment, each parity group of a given file includes N data units, K parity units, and R reserve units. In some embodiments, each storage device includes a maximum of a single unit of any type from any one parity group. For example, if the first parity group includes 10 units total (N=6 data units, K=2 parity units, and R=2 reserve units for a total of 10 units), then there must be at least 10 storage devices so that no device contains more than one unit from this particular parity group. In one embodiment, each parity group associated with a file is allocated the same number of data, parity, and reserve units. For example, if the first parity group includes 6 data units, 2 parity units, and 2 reserve units, then each parity group for the file includes 6 data units, 2 parity units, and 2 reserve units. In some embodiments, each parity group of a first file may include the same number of data, parity, and reserve units, and each parity group of a second file may include a different number of data, parity, and/or reserve units.

Previous parity declustering (PD) configurations emphasized performance over reliability. The PD configuration described herein improves upon the reliability while maintaining performance. A PD layout for a file can be parameterized by a quadruple (N, K, P, B), where P represents the number of devices in a pool over which segments of a file are striped, in such a way that each stripe sizes B, and for every N data stripes (stripes holding file data), K parity stripes are stored, along with K reserved stripes. A set of such correlated data, parity, and reserve/spare stripes (or units) is called a parity group. Thus a file is viewed as a collection of parity groups, each group being self-sufficient for recovery of any of its K units in case there is any loss of data.

A mapping between storage devices and units of a parity group may be done in such a way that failure of any of the K devices causes uniform load across the remaining P−K devices. In some embodiments, this mapping ensures that no two members of a parity group are assigned to the same storage device. Based on the configurations described herein, failure of any K devices leads to failure of no more than K units from any of the parity groups. Hence such a layout has fault tolerance up to K devices. Members of parity group may be permuted across devices in such a way that load per disk is uniformly distributed during data recovery.

A PD layout with emphasis more on reliability than on performance may support file recovery for more than K failures. Analysis demonstrates that for practical values of parameters (N, K, R, P), the probability of devices following a favorable pattern of failures is relatively high. For example, if we have (N, K, R, P) as (6, 2, 2, 80), then probability of recovering 3 failures is as high as about 93%.

In some embodiments, an administrator may select a permutation for a given file. Additionally, or alternatively, a random layout attribute may be selected per file. For example, a first file may be allocated based on (N, K, R, P) of (6, 2, 2, 60), which at least a portion of may be selected by an administrator and/or randomly selected, while a second file may be allocated based on (N, K, R, P) of (8, 4, 4, 60), which also at least a portion of may be selected by an administrator and/or randomly selected. Selecting different and/or random layout attributes per file may improve the performance of recovery across all files having HRPD layout while maintaining good performance. Using a different permutation for each file, recovery of all files may fail when the number of failed devices, M, is greater than the number of parity units, K. If there are F number of files using HRPD layout, each having the same layout attributes (i.e., same N, K, R, P), each using a different permutation for mapping its parity groups to available set of devices, then the probability of survival of any single file may depend upon on the pattern of failures, and the probability of survival will be independent of survival of any other file. As an example, if K=2, and the probability of surviving 3 failures is as high as 93%, then on average 93 files out of 100 files survive the failure. An alternate approach could be using the same layout attributes (N, K, R, P) for each file and suing the same permutation for each file, which may ensure that if a single file survives for a given failure pattern of M>K failures, then all files having the same layout attributes, and permutation survive, but if a single file fails then all files having the same layout attributes and permutation fail.

Although varying layout attributes may result in different permutations, in some embodiments, different permutations may result in different files using the same layout attributes (N, K, R, P). For example, parameters and/or aspects of each file may result in different permutations for each file using the same layout attributes. As one example, two files using the same layout attributes may have different permutations because the two files have different file sizes, resulting in a different number of parity groups for each file.

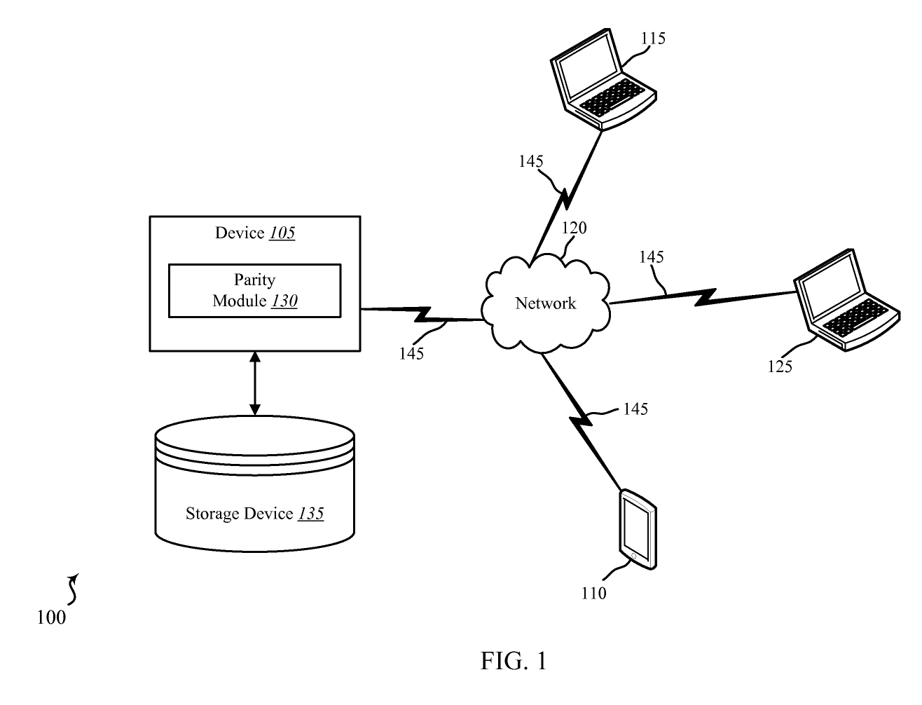

FIG. 1 is an example of a system 100 in accordance with various aspects of the disclosure. In some embodiments, the system 100 may include one or more devices 105, 110, 115, 125, and network 120. Device 105 may communicate via wired or wireless communication links 145 with one or more of the client computing device 110, 115, 125, and/or network 120. The network 120 may enable devices 105, 110, 115, and/or 125 to communicate via wired or wireless communication links 145. In alternate embodiments, the network 120 may be integrated with any one of the device 105, 110, 115, 125, such that each device may communicate with one of the other devices directly, such as device 105 communicating directly with device 110 using a wireless and/or wired connection.

Device 105 may include parity module 130 and storage device 135. Parity module 130 may enable device 105 to receive data from one or more of devices 110, 115, 125, and/or network 120. Parity module 130 may divide the received data into several segments and form a parity group for each segment. Parity module 130 may generate data units for each file segment as well as parity and reserve units. Thus, each parity group may include a group of data units, parity units, and reserve units. Parity module 130 may store the parity groups on the storage device 135. Further description regarding the operations of parity module 130 are provided herein. In some embodiments, at least one of the devices 110, 115, and 125 includes a parity module (e.g., parity module 130). For example, each of the devices 110, 115, and 125 may include a parity module. Thus, in conjunction with a parity module, each device 110, 115, and 125 may send data as well as parity over the network 120 to a storage server, one or more central storage devices, a distributed storage system, etc.

Examples of storage device 135 may include a hard disk drive, a solid state drive, a hybrid drive, and the like. In some cases, storage device 135 may represent two or more storage devices. For example, storage device 135 may include an array of storage devices. In one embodiment, storage device 135 includes a device enclosure with one or more trays of storage devices. Additionally, or alternatively, storage device 135 may include a distributed system of storage devices such as a cloud storage system.

Client computing devices 110, 115, and 125 may be custom computing entities configured to interact with device 105 in conjunction with network 120. In some embodiments, client computing device 110, 115, 125 may include computing entities such as a personal computing device, a desktop computer, a laptop computer, a netbook, a tablet personal computer, a control panel, an indicator panel, a smart phone, a mobile phone, a personal digital assistant (PDA), and/or any other suitable device operable to send and receive signals, store and retrieve data, and/or execute modules.

In some embodiments, devices 110, 115, and/or 125 may be located remotely from device 105. In some cases, one or more of devices 110, 115, and/or 125 may connect locally to device 105. The devices 105, 110, 115, and/or 125 may include memory, a processor, an output, a data input and a communication module. The processor may be a general purpose processor, a Field Programmable Gate Array (FPGA), an Application Specific Integrated Circuit (ASIC), a Digital Signal Processor (DSP), and/or the like. The processor may be configured to retrieve data from and/or write data to the memory. The memory may be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, cloud storage, and/or so forth. In some embodiments, the devices 105, 110, 115, and/or 125 may include one or more hardware-based modules (e.g., DSP, FPGA, ASIC) and/or software-based modules (e.g., a module of computer code stored at the memory and executed at the processor, a set of processor-readable instructions that may be stored at the memory and executed at the processor) associated with executing an application, such as, for example, parity module 130. In some cases, parity module 130 may be associated with executing a software application. In some embodiments, parity module 130 may include one or more processors, memory, hardware, firmware, and/or software code. Parity module 130 may enable at least one of client computing device 110, 115, and/or 125 to establish a connection and/or communicate with device 105. For example, device 105, in conjunction with parity module 130, may store data in a layout that improves the reliability of recovering data when a storage device failure occurs. The client computing devices 110, 115, and/or 125 may be enabled to monitor device 105. The client computing devices 110, 115, and/or 125 may be operable to receive data streams from and/or send signals to device 105 via the network 120.

Examples of networks 120 include cloud networks, local area networks (LAN), wide area networks (WAN), virtual private networks (VPN), a personal area network, near-field communication (NFC), a telecommunications network, wireless networks (using 802.11, for example), and/or cellular networks (using 3G and/or LTE, for example), etc. In some configurations, the network 120 may include the Internet and/or an intranet. The devices 105, 110, 115, and/or 125 may receive and/or send signals over the network 120 via wireless communication links 145. In some embodiments, a user may access the functions of client computing device 110, 115, 125 from device 105. Additionally, or alternatively, a user may access functions of device 105 via client computing devices 110, 115, and 125. For example, in some embodiments, device 105 may include a mobile software application that interfaces with one or more functions of client computing devices 110, 115, and/or 125.

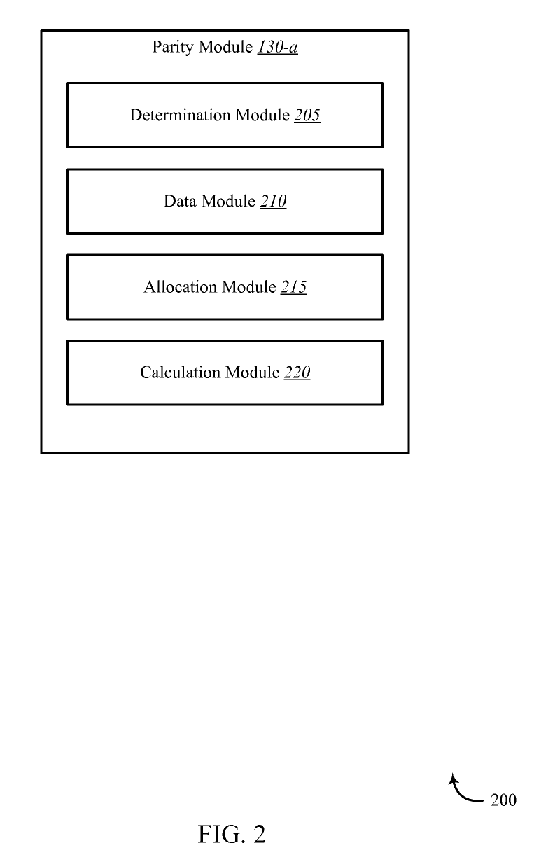

FIG. 2 shows a block diagram 200 of a parity module 130-a. The parity module 130-a may include one or more processors, memory, and/or one or more storage devices. The parity module 130-a may include determination module 205, data module 210, allocation module 215, calculation module 220. The parity module 130-a may be one example of parity module 130 of FIGS. 1 and/or 2. Each of these components may be in communication with each other. The parity module 130-a may be configured to identify a file and store the identified file over a given number of available storage devices. The parity module 130-a may divide the file into segments and spread the segments over the number of available storage devices to increase the likelihood of recovering the file if one or more of the available storage devices fails.

In one embodiment, the determination module 205 may determine a number of available storage devices. For example, the determination module 205 may determine there are 100 available storage devices. In some cases, an administrator may specify the number of available storage devices. Additionally, or alternatively, the determination module 205 may perform a query for the available storage devices. For example, the determination module 205 may query a data server and the data server may reply with the number of storage devices associated with the server.

In some embodiments, the determination module 205 may determine a sequential order for the number of available storage devices from a first storage device to a last storage device. For example, the determination module 205 may determine there are 60 available storage devices. The determination module 205 may select one of the 60 devices as a first storage device, a different storage device of the 60 devices as a second storage device, and continue with this sequential selection until the last remaining storage device is identified as the last storage device. Thus, the determination module 205 may order the available storage devices in a sequential order from a first storage device to a last storage device.

In one embodiment, the data module 210 may identify a file to be stored across the available storage devices. The data module 210 may divide and/or allocate the file into a number of data units. In some cases, the data module 210 may predetermine the number of data units into which to divide the file. In some embodiments, the predetermined number of data units may be based on the size of the file. In some cases, the predetermined number of data units may be set by an administrator. Additionally, or alternatively, the predetermined number of data units may be set based on the number of available storage devices. A length of a given data unit may be measured as a bit or byte value. As one example, the determination module 205 may determine a length of a data unit to be 32 bytes. Thus, data module 210 may divide a 1 KB file into 32 data units of 32 bytes each.

In one embodiment, the data module 210 may assign the data units to a first parity group. The first parity group may be one of several parity groups associated with the file. In some cases, data module 210 may generate a number of parity units for the given number of data units in the first parity group. Additionally, data module 210 may generate a number of reserve units for the given number of data units in the first parity group. In some cases, the number of reserve units may be equal to the number of parity units. In some embodiments, the size of a data unit, parity unit, and reserve unit may be equal. In some cases, the number of data units, parity units, and/or reserve units may be predetermined by the data module 210.

In one embodiment, the allocation module 215 may allocate the data units, the parity units, and the reserve units of the first parity group over the number of available storage devices. In some cases, allocation module 215 may allocate the data units, parity units, and reserve units of the first parity group in a predetermined sequential order of the available storage devices. Upon reaching the last storage device while allocating data, parity, and reserve units from the one or more parity groups and determining one or more units remain unallocated, allocation module 215 may continue to allocate the one or more remaining unallocated units in the determined sequential order starting over at the first storage device. Each time the last storage drive is reached and units remain unallocated, the allocation module 215 may start over at the first storage device and continue allocating the remaining units from there in the predetermined sequential order, one unit per drive. In one embodiment, a storage device includes a maximum of one data unit per parity group.

In some embodiments, the allocation module 215 may allocate first the data units, then the parity units, and then the reserve units. In some cases, a single data unit, parity unit, or reserve unit is allocated per storage device. Thus, given 10 available storage devices ordered sequentially from first storage device to tenth storage device, and given 6 units per parity group (e.g., N=2 data units, K=2 parity units, and R=2 reserve units), the first six storage devices may include the six data units of the first parity group, respectively. The last four storage devices (seventh to tenth) then include the first four units of the second parity group, and wrapping back to the first storage device, the first and second storage devices include the last two units of the second parity group, respectively. From there, allocation continues sequentially until no units remain to be allocated.

The determination module 205 may determine whether one or more of the 100 available storage devices fails. Upon detecting a failure among at least one of the available storage devices, the determination module 205 may determine whether a file is recoverable based on the number of storage device failures among one or more parity groups. In some cases, the determination module 205 may determine whether a file is recoverable based on the number of storage device failures among a cycle, or tile, of parity groups. If the number of storage device failures in all parity groups from a given tile is no greater than the predetermined number of parity units, then the determination module 205 may determine the file is recoverable. For example, a file may be divided into 50 parity groups, and each of these 50 parity groups may include N=6 data units, K=2 parity units, and R=2 reserve units. In this case, each parity groups has 10 total units (e.g., 6 data units plus 2 parity units plus 2 reserve units). Given P=100 available storage devices, the determination module 205 may determine a file is recoverable if there are no more than two failed devices among any one of the 50 parity groups, since K=2. If K=3, then the determination module 205 may determine a file is recoverable if there are no more than three failed devices among any one of the 50 parity groups. There may be more than K failed devices overall among the 100 available storage devices, but as long as there are no more than K device failures for any given parity group, the file remains recoverable based on the layout configuration described herein.

Upon detecting a failure with one or more storage devices associated with a given parity group, data module 210, in conjunction with calculation module 220, may use a remainder of operating storage devices associated with the given parity group to recover the data lost by the one or more storage devices that failed. In one embodiment, the calculation module 220 may calculate a unit sum. In some cases, the unit sum may be based at least in part on a sum of the predetermined number of data units, the predetermined number of parity units, and/or the predetermined number of reserve units in a given parity group. In some cases, a pattern of mapping between the one or more parity groups and the number of available storage devices may be periodic based on a cycle value. The cycle value may be based at least in part on a least common multiple of the number of available storage devices and the unit sum. In some embodiments, the cycle value may be based at least in part on dividing the least common multiple of the number of available storage devices and the unit sum by the unit sum. Upon detecting a failure among at least one of the number of available storage devices, the determination module 205 may determine the file is recoverable if the number of recoverable parity groups is equal to or greater than the cycle value. In some cases, the determination module 205 determines the file is recoverable if the number of consecutive, recoverable parity groups is equal to or greater than the cycle value.

Thus, the data module 210 may divide a 1 KB file into 32 data units of 32 bytes each. The data module 210 may set the number of data units per parity group to four (N=4), the number of parity units per parity group to 2 (K=2), and the number of reserve units per parity group to 2 (R=K=2). Thus, a first parity group of the file may include 4 data units of 32 bytes each, 2 parity units of 32 bytes each, and 2 reserve units of 32 bytes each, for a total of 8 units of 32 bytes each per parity group. The determination module 205 may determine there are 64 available storage devices and sequentially order the 64 available storage devices from first storage device to 64^{th} storage device. The allocation module 215 may allocate the first data unit of the first parity group to the first storage device, the second data unit of the first parity group to the second storage device, the third data unit of the first parity group to the third storage device, and so forth. The allocation module 215 may wrap around back to the first storage device each time a unit of a parity group is allocated to the 64^{th} storage device and may continue allocating units from each parity group until the last unit of the last parity group is allocated.

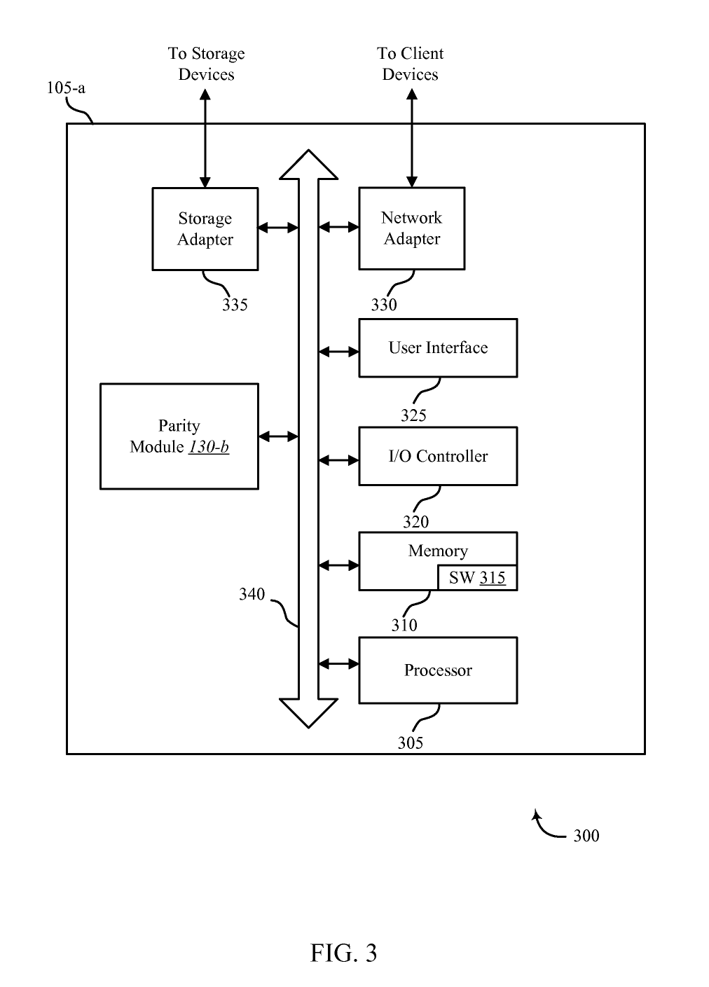

FIG. 3 shows a system 300 for high reliability parity declustering, in accordance with various examples. System 300 may include an apparatus 105-a, which may be an example of device 105. Additionally, or alternatively, apparatus 105-a may be, at least in part, an example of devices 110, 115, and/or 125 of FIG. 1.

Apparatus 105-a may include components for bi-directional voice and data communications including components for transmitting communications and components for receiving communications. For example, apparatus 105-a may communicate bi-directionally with one or more storage devices and/or client systems. This bi-directional communication may be direct (e.g., apparatus 105-a communicating directly with a storage system) and/or indirect (e.g., apparatus 105-a communicating indirectly with a client device through a server).

Apparatus 105-a may also include a processor module 305, and memory 310 (including software/firmware code (SW) 315), an input/output controller module 320, a user interface module 325, a network adapter 330, and a storage adapter 335. The software/firmware code 315 may be one example of a software application executing on apparatus 105-a. The network adapter 330 may communicate bi-directionally—via one or more wired links and/or wireless links—with one or more networks and/or client devices. In some embodiments, network adapter 330 may provide a direct connection to a client device via a direct network link to the Internet via a POP (point of presence). In some embodiments, network adapter 330 of apparatus 105-a may provide a connection using wireless techniques, including digital cellular telephone connection, Cellular Digital Packet Data (CDPD) connection, digital satellite data connection, and/or another connection. The apparatus 105-a may include a parity module 130-b, which may perform the functions described above for the parity modules 130 of FIGS. 1, and/or 2.

The signals associated with system 300 may include wireless communication signals such as radio frequency, electromagnetics, local area network (LAN), wide area network (WAN), virtual private network (VPN), wireless network (using 802.11, for example), cellular network (using 3G and/or LTE, for example), and/or other signals. The network adapter 330 may enable one or more of WWAN (GSM, CDMA, and WCDMA), WLAN (including Wi-Fi), WMAN (WiMAX) for mobile communications, antennas for Wireless Personal Area Network (WPAN) applications (including RFID and UWB), etc.

One or more buses 340 may allow data communication between one or more elements of apparatus 105-a (e.g., processor module 305, memory 310, I/O controller module 320, user interface module 325, network adapter 330, and storage adapter 335, etc.).

The memory 310 may include random access memory (RAM), read only memory (ROM), flash RAM, and/or other types. The memory 310 may store computer-readable, computer-executable software/firmware code 315 including instructions that, when executed, cause the processor module 305 to perform various functions described in this disclosure. Alternatively, the software/firmware code 315 may not be directly executable by the processor module 305 but may cause a computer (e.g., when compiled and executed) to perform functions described herein. Alternatively, the computer-readable, computer-executable software/firmware code 315 may not be directly executable by the processor module 305, but may be configured to cause a computer (e.g., when compiled and executed) to perform functions described herein. The processor module 305 may include an intelligent hardware device, e.g., a central processing unit (CPU), a microcontroller, an application-specific integrated circuit (ASIC), etc.

In some embodiments, the memory 310 can contain, among other things, the Basic Input-Output system (BIOS) which may control basic hardware and/or software operation such as the interaction with peripheral components or devices. For example, the parity module 130-b to implement the present systems and methods may be stored within the system memory 310. Applications resident with system 300 are generally stored on and accessed via a non-transitory computer readable medium, such as a hard disk drive or other storage medium. Additionally, applications can be in the form of electronic signals modulated in accordance with the application and data communication technology when accessed via a network interface (e.g., network adapter 330, etc.).

Many other devices and/or subsystems may be connected to one or may be included as one or more elements of system 300 (e.g., personal computing device, mobile computing device, smart phone, server, internet-connected device, cell radio module, and so on). In some embodiments, all of the elements shown in FIG. 3 need not be present to practice the present systems and methods. The devices and subsystems can be interconnected in different ways from that shown in FIG. 3. In some embodiments, an aspect of some operation of a system, such as that shown in FIG. 3, may be readily known in the art and are not discussed in detail in this application. Code to implement the present disclosure can be stored in a non-transitory computer-readable medium such as one or more of system memory 310 or other memory. The operating system provided on I/O controller module 320 may be a mobile device operating system, desktop/laptop operating system, server operating system, or another known operating system.

The I/O controller module 320 may operate in conjunction with network adapter 330 and/or storage adapter 335. The network adapter 330 may enable apparatus 105-a with the ability to communicate with client devices (e.g., devices 110, 115, and/or 125 of FIG. 1), and/or other devices over the network 120 of FIG. 1. Network adapter 330 may provide wired and/or wireless network connections. In some cases, network adapter 330 may include an Ethernet adapter or Fibre Channel adapter. Storage adapter 335 may enable apparatus 105-a to access one or more data storage devices (e.g., storage device 135). The one or more data storage devices may include a parity declustered configuration. The storage adapter may include one or more of an Ethernet adapter, a Fibre Channel adapter, Fibre Channel Protocol (FCP) adapter, a SCSI adapter, and iSCSI protocol adapter.

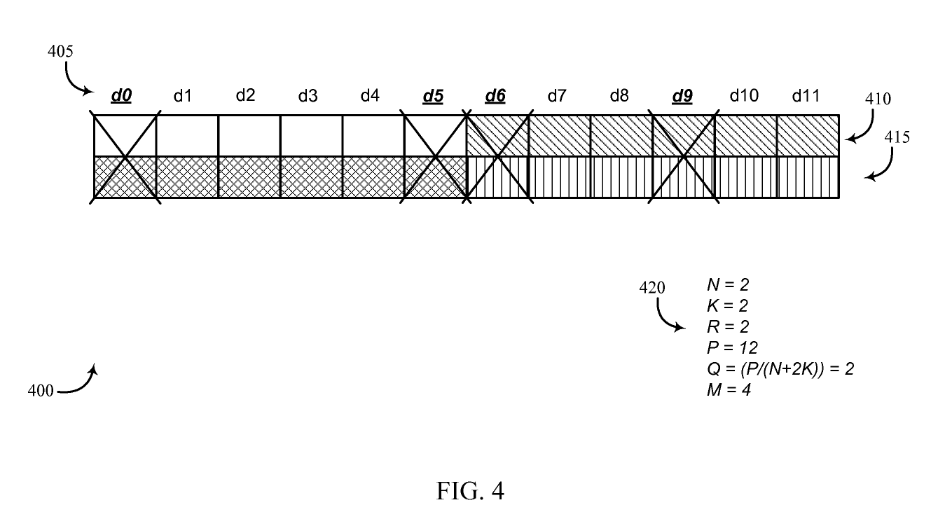

FIG. 4 shows a diagram of an example parity declustering layout 400 in accordance with various aspects of this disclosure. The layout 400 includes a group of storage devices 405. As illustrated the group of devices 405 includes twelve devices, d0 through d11. The first row 410 and second row 415 illustrate storage space within any given storage device. For example, each space under device d0 represents storage space within device d0, etc. Layout 400 demonstrates a version of high reliability parity declustering (HRPD) layout. Any permutation function that applies to all columns of a layout may satisfy the same reliability property.

The group of devices 405 may include data units, parity units, and reserve units from multiple parity groups of a file. For example, the first row 410 illustrates the allocation of the first two parity groups across the groups of devices 405. The first six devices (d0-d5) includes the units of the first parity group, illustrated as blank-white spaces. The last six devices (d6-d11) includes the units of the second parity group, illustrated as diagonally hatched spaces. The second row 415 includes the allocation of the next two parity groups across the group of devices 405. The first six devices (d0-d5) in the second row 415 illustrates the units of the third parity group, illustrated as cross-hatched spaces. The last six devices (d6-d11) in the second row 415 illustrates the units of the fourth parity group, illustrated as horizontally lined spaces. Although only four parity groups are shown for the given file, it is understood the file may include additional parity groups than the four parity groups shown.

As indicated in the legend 420, each parity group of layout 400 includes 2 data units (N=2), 2 parity units (K=2), 2 reserve units (R=2), 12 storage devices (P=12), and 4 failures (M=4). Also, a value Q is shown based on the number of storage devices, P, number of data units per parity group, N, and number of parity units per parity group, K. In this case, Q is determined to have a value of 2 (i.e., Q=(P/(N+K+R), and so Q=(12/(2+2+2)=12/(6)=2 in this case).

A parity group is a collection of G total units, N of which are data units, K of which are parity units, and R of which are reserve units. A pool of devices is said to have P number of devices. Thus, each parity group includes six total units, as illustrated. In one embodiment, data from a file is divided into equal sized segments. Two of these segments may form the two data units of the first parity group, two different segments may form the two data units of the second parity group, and so forth. For every N data units of a parity group, K parity units may be calculated. In this case, two parity units are calculated for the two data units of each parity group. Also, two reserve units are included in each parity group.

As illustrated, devices d0, d5, d6, and d9 represent failed devices, four in total. Thus, the first and third parity groups have failures on d0 and d5, the second and fourth parity groups have failures on d6 and d9. Even though the total number of failed devices, four, exceeds the value of K, the system remains in a recoverable state by virtue of the fact that no parity group has more than K failures. In FIG. 4, if the first Q parity groups (Q=2) are recoverable, then the entire file is recoverable. FIG. 4 illustrates a case when P is evenly divisible by N+K+R. Where there are more device failures than K (e.g., M>K), then two questions may arise: (1) How to decide whether a particular file is recoverable in a given degraded pool, based upon a pattern of failures for a given quadruple (N, K, P, M)? and (2) For a given quadruple (N, K, P, M), with what probability can a file be recovered using the HRPD layout?

In some embodiments, the units of a parity group may be allocated based on a predetermined order. For example, the data units of the first parity group may be allocated first, followed by the parity units, then the reserve units (e.g., d0(N1), d1(N2), d2(K1), d3(K2), d4(R1), d5(R2)). Alternatively, the units of each parity group may be allocated across the devices in a random order (e.g., d0(K2), d1(R1), d2(K1), d3(N1), d4(R2), d5(N2) for the first parity group and d6(N2), d7(K1), d8(R1), d9(N1), d10(K2), d11(R2) for the second parity group, etc.). In some embodiments, reordering of units may not be restricted to within a single parity group. Any random permutation may be applied to the columns of FIG. 4. In one example layout, d0 may include N1 from the first and third parity groups, and d8 may include K1 from the second and fourth parity groups. However, in one sample layout, these two columns may be swapped so that d0 includes K1 from the second and fourth parity groups and d8 includes N1 from the first and third parity groups, etc.

In case of failure of up to K units from a parity group, the remaining surviving units associated with the parity group may be used for the recovery. Thus, if devices d0 and d1 were to fail, then devices d2, d3, d4, and d5 may be used to recover the data lost in devices d0 and d1. In one embodiment, the bit size of a parity unit may be the same as the bit size of a data unit. Thus, a file may be viewed as a collection of parity groups. These parity groups may be allocated across the pool of available storage devices. In some cases, one or more of the following criteria are satisfied or exceeded by the layout 400: (1) a file remains recoverable with failure of up to K devices; (2) parity is distributed such that updates that lead to the computation of parity are evenly distributed across the entire pool of devices; (3) in case of failures of up to K devices, from the pool of P devices, the load across remaining P-K devices may be evenly distributed during the recovery process (4) the mapping between file's logical address space and physical disk address may be implemented with relatively minimal computations, as these mappings may be used for every file input/output; (5) large write optimization, where the mapping functions have the property that user data units that are contiguous in the address space of file map to contiguous data units within contiguous parity groups on the physical drives, ensuring that whenever a user performs a write operation that is the size of the data portion of a parity group and starts on a parity group boundary, it is possible to update the corresponding parity unit without pre-reading the prior content of any data or parity units; and (6) offers maximal parallelism, where a read of contiguous user data with size equal to a data unit times the number of disks in the array may induce a single data unit read on all disks in the array, while providing alignment only to a data unit boundary.

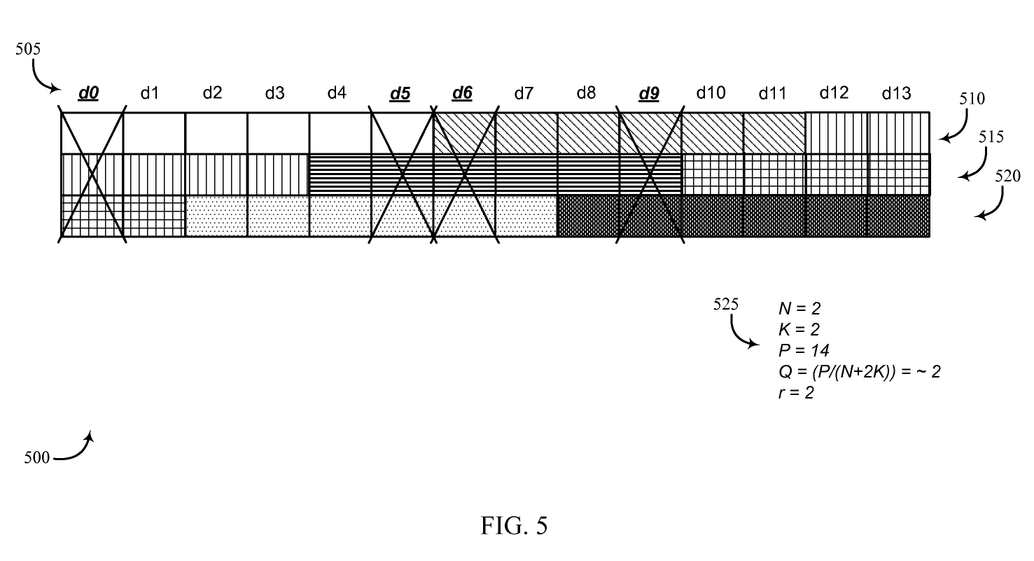

FIG. 5 shows a diagram of another example parity declustering layout 500 in accordance with various aspects of this disclosure. As indicated in the legend 525, each parity group of layout 500 includes 2 data units (N=2), 2 parity units (K=2), 2 reserve units (R=2), 12 storage devices (P=12), and 4 failures (M =4). Layout 500 illustrates a case of when P is not divisible by N+K+R. Parity groups wrap around the pool in such cases. The layout illustrates three rows 510, 515, and 520. Each column represents storage space of a given storage device, similar to FIG. 4.

As with layout 400, layout 500 illustrates failures among devices d0, d5, d6, and d9. Thus, the first parity group has two failures from d0 and d5 going down, the second has two failures from d6 and d9, the third has a single failure from d0, the fourth parity group has three failures from d5, d6, and d9, the fifth parity group has a single failure from d0, the sixth parity group has two failures from d5 and d6, and the seventh parity group has one failure from d9 going down. Layout 500 depicts a case where the file is not recoverable in spite of the fact that the first Q parity groups are recoverable. For the same failure pattern as in layout 400, the file is not recoverable as the fourth parity group has three failures (i.e., greater than K failures per parity group) resulting from failures in storage devices d5, d6, and d9.

For layout 500, after the first seven parity groups the pattern repeats. The layout 500 is periodic, repeating every seven parity groups. For example, the eighth parity group would be allocated to devices d0-d5 just as the first parity group is. After seven additional parity groups (parity groups 8-14) are allocated, the pattern repeats itself again, such that the 15^{th} parity group would be allocated to devices d0-d5, and so forth. Hence, if the first seven parity groups of the file in layout 500 are recoverable then the entire file is recoverable. Thus, there can be more than K failures and still have recovery of the entire file. It is noted, if device d10 in layout 500 went down instead of device d9 and the other failures remained the same, then the entire file would be still be recoverable even though the number of failures (M=4) is greater than the number of parity units per parity group (K=2).

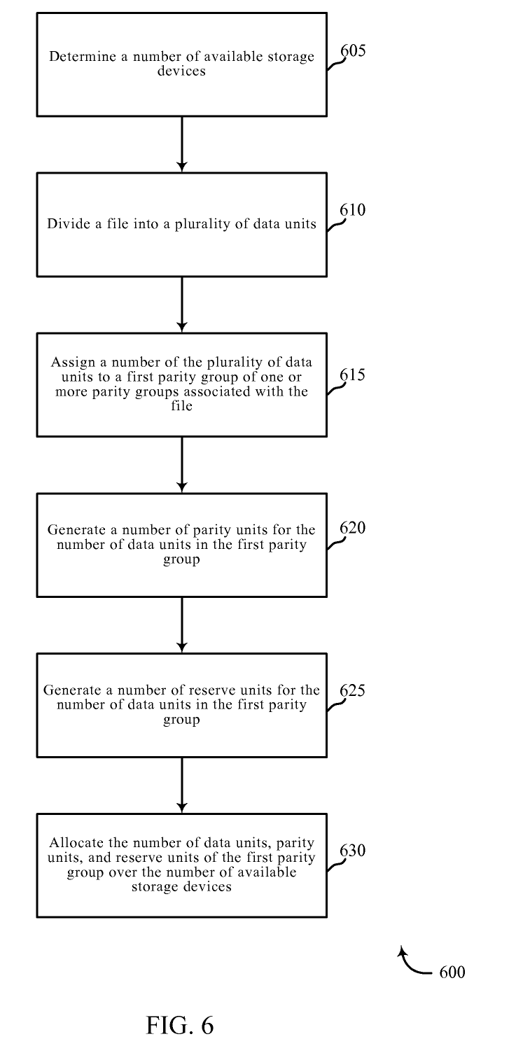

FIG. 6 is a flow chart illustrating an example of a method 600 for high reliability parity declustering, in accordance with various aspects of the present disclosure. The operation(s) at block 605-630 may be performed using the parity module 130 described with reference to FIGS. 1-3 and/or another module.

At block 605, the method may include determining a number of available storage devices. At block 610, the method may include dividing a file into a plurality of data units. At block 615, the method may include assigning a predetermined number of the plurality of data units to a first parity group of one or more parity groups associated with the file. At block 620, the method may include generating a predetermined number of parity units for the predetermined number of data units in the first parity group. At block 625, the method may include generating a predetermined number of reserve units for the predetermined number of data units and the predetermined number of parity units in the first parity group. At block 630, the method may include sequentially allocating the predetermined number of data units, the predetermined number of parity units, and the predetermined number of reserve units of the first parity group over the number of available storage devices. In some embodiments, the method 600 may include sequentially mapping the units from parity groups generated in block 615, to the available pool of devices. Supposing the available P devices is enumerated from 0 to (P−1), the method may include enumerating the parity groups and the units from the parity groups, and assigning a unique index for each unit. With the îth unit from ĵth parity group, the method may include associating an index idx=j*G+i. The method may associate this unit with the device with index idx modulo P, where an operation of the form a modulo b generates a remainder left after dividing a by b.

Thus, the method 600 may provide for high reliability parity declustering relating to high reliability parity declustering. It should be noted that the method 600 is just one implementation and that the operations of the method 600 may be rearranged, omitted, and/or otherwise modified such that other implementations are possible and contemplated.

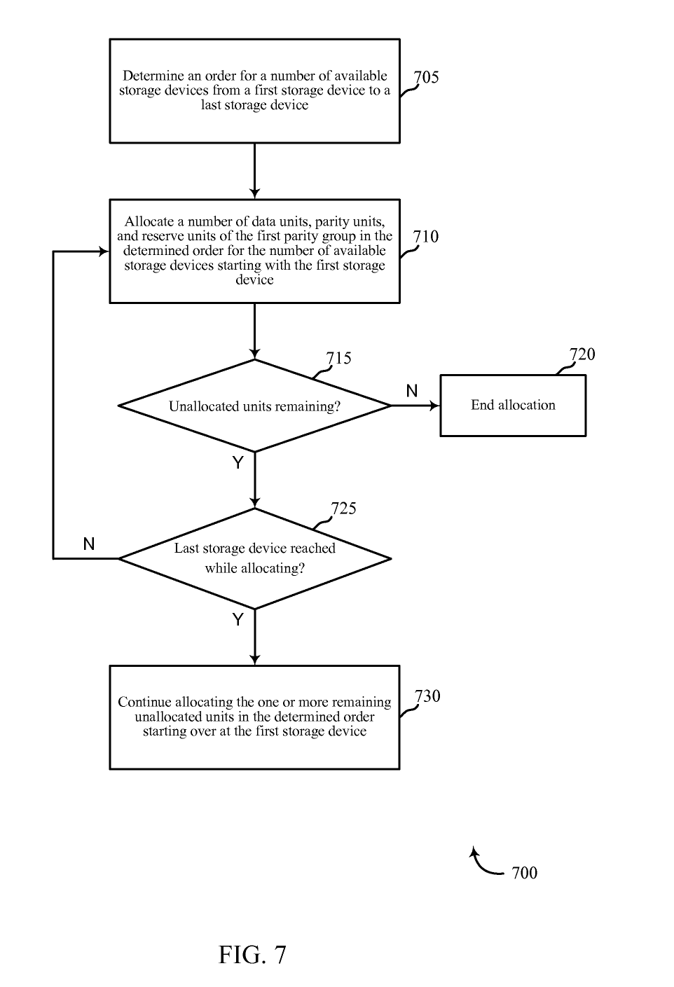

FIG. 7 is a flow chart illustrating an example of a method 700 for high reliability parity declustering, in accordance with various aspects of the present disclosure. The operation(s) at block 705-725 may be performed using the parity module 130 described with reference to FIGS. 1-3 and/or another module.

At block 705, the method may include determining a sequential order for the number of available storage devices from a first storage device to a last storage device. At block 710, the method may include allocating the predetermined number of data units, predetermined number of parity units, and predetermined number of reserve units of the first parity group in the determined sequential order for the number of available storage devices. In some embodiments, the method may include allocating first the predetermined number of data units, then the predetermined number of parity units, and then the predetermined number of reserve units. In some cases, a single data unit, parity unit, or reserve unit is allocated per storage device. In one embodiment, the number of reserve units may be equal to the number of parity units per parity group.

At block 715, after allocating at least one unit (data unit, parity unit, and/or reserve unit), the method may determine whether there are any unallocated units remaining. In some cases, the method may check to see if units remain unallocated after each allocation of a unit. Upon determining all the units are allocated, at block 720, the method may end allocation. On the other hand, if the method determines one or more units remain unallocated, at block 725, the method may determine whether allocation has reached the last storage device. In some cases, the method may determine whether the last unit allocated was allocated to the last storage device. If the method determines the last storage device has not been reached, then the method continues allocation at block 710. Conversely, upon reaching the last storage device while allocating data, parity, and reserve units from the one or more parity groups and determining one or more units remain unallocated, at block 725, the method may continue to allocate the one or more remaining unallocated units in the determined sequential order starting over at the first storage device. Thus, after allocating a unit to the last storage device with unallocated units remaining, the method may allocate the next unit at the first storage device, continuing to allocate the units in the sequential order starting over at the first storage device each time the last storage device is reached with unallocated units remaining to be allocated.

Thus, the method 700 may provide for high reliability parity declustering relating to high reliability parity declustering. It should be noted that the method 700 is just one implementation and that the operations of the method 700 may be rearranged, omitted, and/or otherwise modified such that other implementations are possible and contemplated.

In some examples, aspects from two or more of the methods 600 and 700 may be combined and/or separated. It should be noted that the methods 600 and 700 are just example implementations, and that the operations of the methods 600 and 700 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration.

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

This disclosure may specifically apply to security system applications. This disclosure may specifically apply to storage system applications. In some embodiments, the concepts, the technical descriptions, the features, the methods, the ideas, and/or the descriptions may specifically apply to storage and/or data security system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A method for parity declustering, comprising:
determining a number of available storage devices;
dividing a file into a plurality of data units;
assigning a number of the plurality of data units to a first parity group of one or more parity groups associated with the file;
generating a number of parity units for the number of data units in the first parity group;
generating a number of reserve units for the number of data units and the number of parity units in the first parity group; and
allocating the number of data units, the number of parity units, and the number of reserve units of the first parity group across the number of available storage devices.

2. The method of claim 1, comprising:
determining a sequential order for the number of available storage devices from a first storage device to a last storage device.

3. The method of claim 2, comprising:
allocating the number of data units, number of parity units, and number of reserve units of the first parity group in the determined sequential order for the number of available storage devices.

4. The method of claim 2, comprising:
upon reaching the last storage device while allocating data, parity, and reserve units from the one or more parity groups and determining one or more units remain unallocated, continuing to allocate the one or more remaining unallocated units in the determined sequential order starting over at the first storage device.

5. The method of claim 1, comprising:
allocating first the number of data units, then the number of parity units, and then the number of reserve units, wherein a single data unit, parity unit, or reserve unit is allocated per storage device.

6. The method of claim 1, comprising:
calculating a unit sum, the unit sum being based at least in part on a sum of the number of data units, the number of parity units, and the number of reserve units in the first parity group.

7. The method of claim 6, comprising:
upon detecting a failure among at least one of the available storage devices, determining the file is recoverable if each of the one or more parity groups associated with the file has no more storage device failures than the number of parity units.

8. The method of claim 1, comprising:
wherein a pattern of mapping between the one or more parity groups and the number of available storage devices is periodic based on a cycle value, the cycle value being based at least in part on a least common multiple of the number of available storage devices and the unit sum.

9. The method of claim 8, comprising:
wherein the cycle value is based at least in part on dividing the least common multiple of the number of available storage devices and the unit sum by the unit sum.

10. The method of claim 8, comprising:
upon detecting a failure among at least one of the number of available storage devices, determining the file is recoverable if the number of recoverable parity groups is equal to or greater than the cycle value.

11. The method of claim 1, comprising:
upon detecting a failure with at least one storage device associated with the first parity group, using a remainder of operating storage devices associated with the first parity group to recover data from the at least one storage device that failed.

12. The method of claim 1, wherein the number of reserve units is equal to the number of parity units.

13. A computing device configured for parity declustering, comprising:
a processor;
memory in electronic communication with the processor, wherein the memory stores computer executable instructions that when executed by the processor cause the processor to perform the steps of:
determining a number of available storage devices;
allocating a file into a plurality of data units;
assigning a number of the plurality of data units to a first parity group of one or more parity groups associated with the file;
generating a number of parity units for the number of data units in the first parity group;
generating a number of reserve units for the number of data units and the number of parity units in the first parity group; and
allocating the number of data units, the number of parity units, and the number of reserve units of the first parity group over the number of available storage devices.

14. The computing device of claim 13, wherein the instructions executed by the processor cause the processor to perform the steps of:
determining a sequential order for the number of available storage devices from a first storage device to a last storage device.

15. The computing device of claim 14, wherein the instructions executed by the processor cause the processor to perform the steps of:
allocating the number of data units, number of parity units, and number of reserve units of the first parity group in the determined sequential order for the number of available storage devices.

16. The computing device of claim 14, wherein the instructions executed by the processor cause the processor to perform the steps of:
upon reaching the last storage device while allocating data, parity, and reserve units from the one or more parity groups and determining one or more units remain unallocated, continuing to allocate the one or more remaining unallocated units in the determined sequential order starting over at the first storage device.

17. The computing device of claim 13, wherein the instructions executed by the processor cause the processor to perform the steps of:
allocating first the number of data units, then the number of parity units, and then the number of reserve units, wherein a single data unit, parity unit, or reserve unit is allocated per storage device.

18. The computing device of claim 13, wherein the instructions executed by the processor cause the processor to perform the steps of:
calculating a unit sum, the unit sum being based at least in part on a sum of the number of data units, the number of parity units, and the number of reserve units in the first parity group.

19. A storage controller configured for parity declustering, the storage controller comprising:
a plurality of storage devices;
a processor determining a number of available storage devices among the plurality of storage devices;
a network interface receiving a file;
the processor dividing the file into a plurality of data units;
the processor assigning a number of the plurality of data units to a first parity group of one or more parity groups associated with the file;
the processor generating a number of parity units for the number of data units in the first parity group;
the processor generating a number of reserve units for the number of data units and the number of parity units in the first parity group; and
the processor sequentially allocating the number of data units, the number of parity units, and the number of reserve units of the first parity group over the number of available storage devices.

20. The storage controller of claim 19, comprising:
the processor determining a sequential order for the number of available storage devices from a first storage device to a last storage device; and
the processor allocating the number of data units, number of parity units, and number of reserve units of the first parity group in the determined sequential order for the number of available storage devices.
